(19) United States
(12) Patent Application Publication
(10) Pub. No.: US 2016/0312470 A1
(43) Pub. Date: Oct. 27, 2016

(54) HIGHLY LOADED THERMOPLASTIC MEMBRANES WITH IMPROVED MECHANICAL PROPERTIES

(71) Applicant: FIRESTONE BUILDING PRODUCTS CO., LLC, Indianapolis, IN (US)

(72) Inventors: Hao WANG, Carmel, IN (US); Donna TIPPMANN, Fishers, IN (US); Michael John HUBBARD, Anderson, IN (US)

(21) Appl. No.: 15/103,542

(22) PCT Filed: Dec. 12, 2014
(86) PCT No.: PCT/US2014/069988

§ 371 Date: Jun. 10, 2016

Related U.S. Application Data
(60) Provisional application No. 61/915,183, filed on Dec. 12, 2013.

(51) Int. Cl. E04D 5/14; B32B 27/32; E04D 5/08; E04D 5/10; E04D 5/06; B32B 27/20; B32B 7/08

(52) U.S. Cl. CPC E04D 5/145; B32B 27/20; B32B 27/32; B32B 7/08; E04D 5/10; E04D 5/06; E04D 5/08; B32B 2264/104; B32B 2264/102; B32B 2419/06

(57) ABSTRACT

A thermoplastic roofing membrane comprising a planar sheet of thermoplastic polymer, optionally having more than one layer, where at least one layer of the membrane includes a functionalized thermoplastic polymer and at least 10 percent by weight filler, based on the total weight of the at least one layer.

This application claims the benefit of U.S. Provisional Application Ser. No. 61/915,183, which was filed on Dec. 12, 2013, and is incorporated herein by reference.

### FIELD OF THE INVENTION

Embodiments of the present invention are directed toward thermoplastic membranes that include one or more polymeric layers including high loading of inorganic filler and functionalized thermoplastic polymer.

### BACKGROUND OF THE INVENTION

Flat or low-sloped roofs are often covered with polymeric membranes. Common among the membranes that have the mechanical properties needed to be technologically useful are thermoplastic membranes prepared with propylene-based polymers and copolymers, which are commonly referred to as thermoplastic polyolefins. One thermoplastic polyolefin commonly employed in the art is an ethylene-propylene reactor copolymer. In addition to the thermoplastic polyolefin, these membranes typically include a variety of additives. For example, the membranes may include mineral fillers, such as magnesium hydroxide, which act as a flame retardant. Since the membranes are relatively thin, and yet must meet a variety of performance standards, care must be taken when selecting additives because they tend to diminish the physical properties of the membrane. For example, the amount of mineral filler that can be added to the membrane composition is limited since the physical properties of the membrane diminish with increasing filler loadings.

Thermoplastic membranes can be attached to a roof surface using several modes of attachment that primarily seek to prevent wind uplift of the membrane panels. These modes include, but are not limited to, affixing the various membrane panels to the roof surface by employing mechanical fasteners, ballasts, and adhesives. Attachment to the roof surface by mechanical fastening is often viewed as cost-effective and therefore it is commonly used in the art. This mode of attachment places very stringent requirements on the mechanical properties of the membrane. For example, in order for a membrane to be mechanically attached to a roof, ASTM D6878 requires that the membrane have a break strength of at least 220 lbf (976N) and a tear strength of at least 55 lbf (245N). While most polyolefinic compositions can meet these requirements, the addition of additives, such as mineral fillers, especially those mineral fillers that are not surface functionalized or surface modified, can quickly erode the break strength and tear strength such that the membranes may no longer be useful especially for mechanically-attached roof systems.

### SUMMARY OF THE INVENTION

Embodiments of the present invention provide a thermoplastic roofing membrane comprising a planar sheet of thermoplastic polymer, optionally having more than one layer, where at least one layer of the membrane includes a functionalized thermoplastic polymer and at least 10 percent by weight filler, based on the total weight of the at least one layer.

Other embodiments of the present invention provide a mechanically-attached roofing system comprising a roof substrate, a thermoplastic membrane including at least one layer that includes a functionalized thermoplastic polymer and at least 10 percent by weight filler, based on the total weight of the at least one layer, and fasteners that fasten the thermoplastic membrane to the roof substrate.

Still other embodiments of the present invention provide a method for forming a mechanically-attached roof system, the method comprising applying a membrane to a roof substrate, wherein the membrane includes a planar sheet of thermoplastic polymer, optionally having more than one layer, where at least one layer of the membrane includes a functionalized thermoplastic polymer and at least 10 percent by weight filler, based on the total weight of the at least one layer and mechanically fastening the membrane to the substrate.

### BRIEF DESCRIPTION OF THE DRAWINGS

FIG. 1 is a perspective view of a multi-layered membrane including two coextruded laminated layers according to embodiments of the present invention.

FIG. 2 is a perspective view of a multi-layered membrane including two laminated layers according to embodiments of the present invention.

FIG. 3 is a perspective, cross sectional view of a mechanically-attached roof assembly according to embodiments of the present invention.

### DETAILED DESCRIPTION OF ILLUSTRATIVE EMBODIMENTS

Embodiments of the present invention are based, at least in part, on the discovery of a thermoplastic roofing membrane including at least one layer having a functionalized thermoplastic polymer and a relatively high inorganic filler loading. It has been discovered that these membranes exhibit advantageous break and tear strength despite having relatively high levels of filler. In one or more embodiments, the membranes satisfy the requirements of ASTM D6878. As a result, the membranes of the present invention can be used in mechanically-attached roofing systems and meet industry standards for wind uplift including FM 4470. While the prior art contemplates the use of certain functionalized thermoplastics in roofing membranes, the prior art fails to appreciate that the functionalized thermoplastic polymer allows for increased filler loading while maintaining critical mechanical properties of the membrane thereby allowing the membrane to be used in a mechanically-attached roof system.

### Membrane Construction

In one or more embodiments, the membranes of the present invention include at least two layers laminated to one another with an optional scrim disposed between the layers. In one or more embodiments, both layers include the functionalized thermoplastic polymer and relatively high inorganic filler loading according to the present invention. In other embodiments, one layer of a two-layered, laminated membrane includes the functionalized thermoplastic polymer and relatively high inorganic filler loading according to the present invention. In one or more embodiments, the one layer of the two-layered, laminated membrane that includes the functionalized thermoplastic polymer and relatively high inorganic filler loading is the lower layer or bottom layer of the membrane, which the layer that is contacted to the roof substrate; i.e. the side opposite the surface of the membrane that is exposed to the environment. In yet other embodiments, the one layer of the two-layered, laminated membrane that includes the functionalized thermoplastic polymer and relatively high inorganic filler loading is the upper layer or top layer of the membrane, which the layer that is exposed to the environment and therefore opposite the lower or bottom layer.

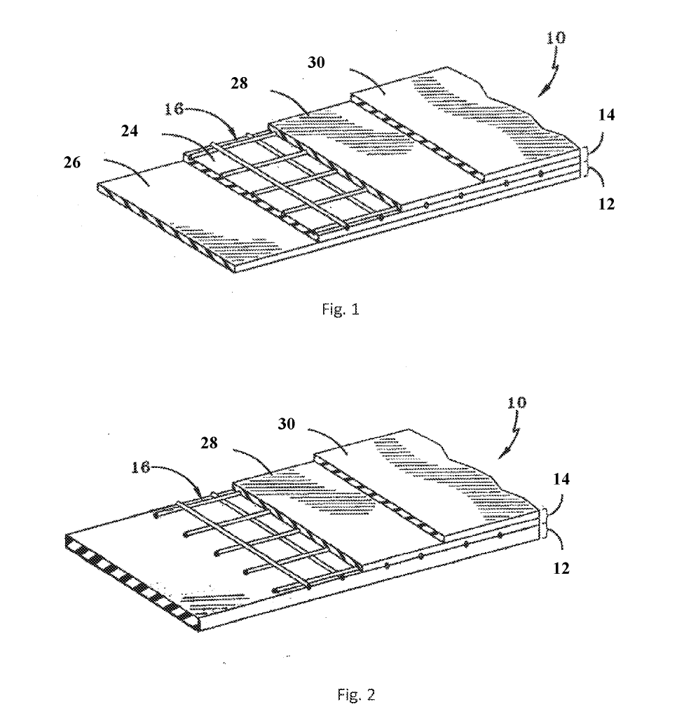

An example of a two-layered, laminated membrane is shown in FIGS. 1 and 2, which show membrane 10 having first or lower layer 12, a second or upper layer 14, and optional scrim 16 disposed there between. In one or more embodiments, lower layer 12 may include functionalized polymer and relatively high loading of filler. In these or other embodiments, upper layer 14 may include functionalized polymer and relatively high loading of filler. In one or more embodiments, one of lower layer 12 and upper layer 14 may be devoid or substantially devoid of functionalized polymer and/or relatively high loadings of filler. Reference to substantially devoid includes that amount or less of a particular constituent (e.g. functionalized polymer) that does not have an appreciable impact on the layer or membrane.

In one or more embodiments, the membranes of the present invention are multi-layered membranes that include one or more coextruded layers. In this respect, U.S. Publ. Nos. 2009/0137168, 2009/0181216, 2009/0269565, 2007/0193167, and 2007/0194482 are incorporated herein by reference. In one or more embodiments, at least one of the coextruded layers includes a functionalized polymer and relatively high loading of mineral filler according to one or more aspects of the present invention. For example, and with reference to FIG. 1, lower or bottom layer 12 includes coextruded layers 24 and 26, and upper layer 14 optionally includes coextruded layers 28 and 30. Lower layer 12 and upper layer 14 may be laminated to each other with optional scrim 16 disposed there between. In one or more embodiments, coextruded layer 26, which may be referred to as bottom coextruded layer 26, includes the functionalized polymer and relatively high filler loading according the present invention. In these or other embodiments, coextruded layer 24, which may be referred to as lower-middle coextruded layer 26, includes the functionalized polymer and relatively high filler loading according the present invention. In certain embodiments, both coextruded layer 26 and coextruded layer 24, include the functionalized polymer and relatively high filler loading according the present invention. In certain embodiments, layers 24 and 26 are compositionally the same, and both layers 24 and 26 include the functionalized polymer and the relatively high filler loading. This embodiment is shown in FIG. 2.

In still other embodiments, coextruded layer 28, which may be referred to as top coextruded layer 30, includes the functionalized polymer and relatively high filler loading according the present invention. In these or other embodiments, coextruded layer 28, which may be referred to as upper-middle coextruded layer 28, includes the functionalized polymer and relatively high filler loading according the present invention. In certain embodiments, both coextruded layer 28 and coextruded layer 30, include the functionalized polymer and relatively high filler loading according the present invention.

In yet other embodiments, both coextruded layers 24 and 28 (i.e. lower-middle layer 24 and upper-middle layer 28) include the functionalized polymer and relatively high filler loading according the present invention. In certain embodiments, coextruded layers 24 and 28 (i.e. lower-middle layer 24 and upper-middle layer 28), as well as bottom coextruded layer 26, include the functionalized polymer and relatively high filler loading according the present invention.

In one or more embodiments, the thickness of coextruded layers 24 and 26 may be the same or substantially similar. In other embodiments, the thickness of coextruded bottom layer 26 may be thinner than coextruded upper layer 24.

In one or more embodiments, the remaining layers of the multi-layered membrane may include the functionalized polymer and/or relatively high loading of mineral filler. In other embodiments, the remaining layers of the multi-layered membrane may be devoid of functionalized polymer and/or mineral filler. For example, the coextruded upper layer 30 may be devoid of the functionalized polymer and/or high loading of mineral filler. Also, the one or more optional coextruded layers of the upper ply (e.g. coextruded layer 28 of ply 14) may be devoid of the functionalized polymer and/or high loading of mineral filler.

In one or more embodiments, the overall thickness of the membranes of the present invention may be from about 20 mils up to about 100 mils, and in certain embodiments from about 30 mils to about 80 mils. The layers (e.g., layers 12 and 14) may each account for about half of the overall thickness (e.g., 10 mils to about 40 mils), with a small fraction of the overall thickness (e.g., about 5 mils) deriving from the presence of the scrim. Where the membrane includes one or more coextruded layers, the bottom layer 26 may, in certain embodiments, have a thickness from about 2 mils to about 20 mils, or in other embodiments from about 4 mils to about 12 mils.

In one or more embodiments, the membranes of the present invention may also be constructed by laminating a thin sheet of polymer having dispersed therein the functionalized polymer to one or more sheets of thermoplastic membrane. For example, a thin film of polymer having the functionalized polymer dispersed therein may be laminated to a conventional thermoplastic membrane or to a component (i.e., the lower layer) of a conventional thermoplastic membrane. The thin sheet having the functionalized polymer dispersed therein may have a thickness of about 2 mils to about 20 mils, or in other embodiments from about 4 mils to about 12 mils.

In one or more embodiments, the scrim may include conventional scrim. For example, polyester scrims may be employed. In these or other embodiments, polyester scrims including fiberglass reinforcement may be employed.

### Constituents of the Membrane Thermoplastic Component

In one or more embodiments, regardless of the number of layers or coextrudates of the membranes, each layer or coextrudate includes a thermoplastic polymer (excluding any scrim reinforcement). Any other ingredients or constituents of each layer is dispersed within the thermoplastic polymer, and therefore reference may be made to a thermoplastic component that forms a matrix in which the other substituents are dispersed. As noted above, at least one layer of the membrane includes a functionalized polymer, which is likewise dispersed within the thermoplastic component or matrix or is co-continuous therewith. Inasmuch as the functionalized polymer may also be a thermoplastic polymer, reference may be made to first and second thermoplastic polymers. For example, the thermoplastic polymer forming the matrix, which accounts for the major volume fraction of any given layer, may be referred to as a first thermoplastic polymer, and where the functionalized polymer is also a thermoplastic polymer, it may be referred to as a second thermoplastic polymer bearing a functionality or group.

In one or more embodiments, the thermoplastic component includes a thermoplastic olefinic polymer, which includes one or more mer units deriving from olefinic monomer. Blends of polymers may also be used. These blends include physical blends as well as reactor blends. In one or more embodiments, the thermoplastic olefinic polymer may derive from recycled thermoplastic polyolefin membranes as described in copending application Ser. No. 11/724,768, which is incorporated herein by reference.

In one or more embodiments, the thermoplastic olefinic polymer may include an olefinic reactor copolymer, which may also be referred to as in-reactor copolymer. Reactor copolymers are generally known in the art and may include blends of olefinic polymers that result from the polymerization of ethylene and α-olefins (e.g., propylene) with sundry catalyst systems. In one or more embodiments, these blends are made by in-reactor sequential polymerization. Reactor copolymers useful in one or more embodiments include those disclosed in U.S. Pat. No. 6,451,897, which is incorporated therein by reference. Reactor copolymers, which are also referred to as TPO resins, are commercially available under the tradename HIFAX™ (Lyondellbassel); these materials are believed to include in-reactor blends of ethylene-propylene rubber and polypropylene or polypropylene copolymers. Other useful thermoplastic olefins include those available under the tradename T00G-00(Ineos). In one or more embodiments, the in-reactor copolymers may be physically blended with other polyolefins. For example, in reactor copolymers may be blended with linear low density polyethene.

In other embodiments, the thermoplastic component may include a physical blend of chemically-distinct olefinic polymers. In one or more embodiments, blends of propylene-based thermoplastic polymer, plastomer, and/or low density polyethylene may be used. In other embodiments, the thermoplastic olefinic component is a blend of a linear low density polyethylene and a propylene-based plastic.

In one or more embodiments, the propylene-based polymer may include polypropylene homopolymer or copolymers of propylene and a comonomer, where the copolymer includes, on a mole basis, a majority of mer units deriving from propylene. In one or more embodiments, the propylene-based copolymers may include from about 2 to about 6 mole percent, and in other embodiments from about 3 to about 5 mole percent mer units deriving from the comonomer with the remainder including mer units deriving from propylene. In one or more embodiments, the comonomer includes at least one of ethylene and an α-olefin. The α-olefins may include butene-1, pentene-1, hexene-1, oxtene-1, or 4-methyl-pentene-1. In one or more embodiments, the copolymers of propylene and a comonomer may include random copolymers. Random copolymers may include those propylene-based copolymers where the comonomer is randomly distributed across the polymer backbone.

The propylene-based polymers employed in one or more embodiments of this invention may be characterized by a melt flow rate of from about 0.5 to about 15 dg/min, in other embodiments from about 0.7 to about 12 dg/min, in other embodiments from about 1 to about 10 dg/min, and in other embodiments from about 1.5 to about 3 dg/min per ASTM D-1238 at 230° C. and 2.16 kg load. In these or other embodiments, the propylene-based polymers may have a weight average molecular weight (M_{w}) of from about 1×10⁵ to about 5×10⁵ g/mole, in other embodiments from about 2×10⁵ to about 4×10⁵ g/mole, and in other embodiments from about 3×10⁵ to about 4×10⁵ g/mole, as measured by GPC with polystyrene standards. The molecular weight distribution of these propylene-based copolymer may be from about 2.5 to about 4, in other embodiments from about 2.7 to about 3.5, and in other embodiments from about 2.8 to about 3.2.

In one or more embodiments, propylene-based polymers may be characterized by a melt temperature (Tₘ) that is from about 165° C. to about 130° C., in other embodiments from about 160 to about 140° C., and in other embodiments from about 155° C. to about 140° C. In one or more embodiments, particularly where the propylene-based polymer is a copolymer of propylene and a comonomer, the melt temperature may be below 160° C., in other embodiments below 155° C., in other embodiments below 150° C., and in other embodiments below 145° C. In one or more embodiments, they may have a crystallization temperature (T_{c}) of about at least 90° C., in other embodiments at least about 95° C., and in other embodiments at least 100° C., with one embodiment ranging from 105° to 115° C.

Also, these propylene-based polymers may be characterized by having a heat of fusion of at least 25 J/g, in other embodiments in excess of 50 J/g, in other embodiments in excess of 100 J/g, and in other embodiments in excess of 140 J/g.

In one or more embodiments, the propylene-based polymers may be characterized by a flexural modulus, which may also be referred to as a 1% secant modulus, in excess of 120,000 psi, in other embodiments in excess of 125,000, in other embodiments in excess of 130,000 psi, in other embodiments in excess of 133,000 psi, in other embodiments in excess of 135,000 psi, and in other embodiments in excess of 137,000 psi, as measured according to ASTM D-790.

Useful propylene-based polymers include those that are commercially available. For example, propylene-based polymers can be obtained under the tradename PP7620Z™ (Fina), PP33BFO1™ (Equistar), or under the tradename TR3020™ (Sunoco).

In one or more embodiments, the thermoplastic polymer may include a blend of olefinic polymers. Useful blends include those described in International Application No. PCT/US06/033522 which is incorporated herein by reference. For example, a particular blend may include (i) a plastomer, (ii) a low density polyethylene, and (iii) a propylene-based polymer.

In one or more embodiments, the plastomer includes an ethylene-α-olefin copolymer. The plastomer employed in one or more embodiments of this invention includes those described in U.S. Pat. Nos. 6,207,754, 6,506,842, 5,226,392, and 5,747,592, which are incorporated herein by reference. This copolymer may include from about 1.0 to about 15 mole percent, in other embodiments from about 2 to about 12, in other embodiments from about 3 to about 9 mole percent, and in other embodiments from about 3.5 to about 8 mole percent mer units deriving from α-olefins, with the balance including mer units deriving from ethylene. The α-olefin employed in preparing the plastomer of one or more embodiments of this invention may include butene-1, pentene-1, hexene-1, octene-1, or 4-methyl-pentene-1.

The plastomer of one or more embodiments of this invention can be characterized by a density of from about 0.865 g/cc to about 0.900 g/cc, in other embodiments from about 0.870 to about 0.890 g/cc, and in other embodiments from about 0.875 to about 0.880 g/cc per ASTM D-792. In these or other embodiments, the density of the plastomers may be less than 0.900 g/cc, in other embodiments less than 0.890 g/cc, in other embodiments less than 0.880 g/cc, and in other embodiments less than 0.875 g/cc.

In one or more embodiments, the plastomer may be characterized by a weight average molecular weight of from about 7×10⁴ to 13×10⁴ g/mole, in other embodiments from about 8×10⁴ to about 12×10⁴ g/mole, and in other embodiments from about 9×10⁴ to about 11×10⁴ g/mole as measured by using GPC with polystyrene standards. In these or other embodiments, the plastomer may be characterized by a weight average molecular weight in excess of 5×10⁴ g/mole, in other embodiments in excess of 6×10⁴ g/mole, in other embodiments in excess of 7×10⁴ g/mole, and in other embodiments in excess of 9×10⁴ g/mole. In these or other embodiments, the plastomer may be characterized by a molecular weight distribution (M_{w}/Mₙ) that is from about 1.5 to 2.8, in other embodiments 1.7 to 2.4, and in other embodiments 2 to 2.3.

In these or other embodiments, the plastomer may be characterized by a melt index of from about 0.1 to about 8, in other embodiments from about 0.3 to about 7, and in other embodiments from about 0.5 to about 5 per ASTM D-1238 at 190° C. and 2.16 kg load.

The uniformity of the comonomer distribution of the plastomer of one or more embodiments, when expressed as a comonomer distribution breadth index value (CDBI), provides for a CDBI of greater than 60, in other embodiments greater than 80, and in other embodiments greater than 90.

In one or more embodiments, the plastomer may be characterized by a DSC melting point curve that exhibits the occurrence of a single melting point break occurring in the region of 50 to 110° C.

The plastomer of one or more embodiments of this invention may be prepared by using a single-site coordination catalyst including metallocene catalyst, which are conventionally known in the art.

Useful plastomers include those that are commercially available. For example, plastomer can be obtained under the tradename EXXACT™ 8201 (ExxonMobil); or under the tradename ENGAGE™ 8180 (Dow DuPont).

In one or more embodiments, the low density polyethylene includes an ethylene-α-olefin copolymer. In one or more embodiments, the low density polyethylene includes linear low density polyethylene. The linear low density polyethylene employed in one or more embodiments of this invention may be similar to that described in U.S. Pat. No. 5,266,392, which is incorporated herein by reference. This copolymer may include from about 2.5 to about 13 mole percent, and in other embodiments from about 3.5 to about 10 mole percent, mer units deriving from α-olefins, with the balance including mer units deriving from ethylene. The α-olefin included in the linear low density polyethylene of one or more embodiments of this invention may include butene-1, pentene-1, hexene-1, octene-1, or 4-methyl-pentene-1. In one or more embodiments, the linear low density polyethylene is devoid or substantially devoid of propylene mer units (i.e., units deriving from propylene). Substantially devoid refers to that amount or less of propylene mer units that would otherwise have an appreciable impact on the copolymer or the compositions of this invention if present.

The linear low density polyethylene of one or more embodiments of this invention can be characterized by a density of from about 0.885 g/cc to about 0.930 g/cc, in other embodiments from about 0.900 g/cc to about 0.920 g/cc, and in other embodiments from about 0.900 g/cc to about 0.910 g/cc per ASTM D-792.

In one or more embodiments, the linear low density polyethylene may be characterized by a weight average molecular weight of from about 1×10⁵ to about 5×10⁵ g/mole, in other embodiments 2×10⁵ to about 10×10⁵ g/mole, in other embodiments from about 5×10⁵ to about 8×10⁵ g/mole, and in other embodiments from about 6×10⁵ to about 7×10⁵ g/mole as measured by GPC with polystyrene standards. In these or other embodiments, the linear low density polyethylene may be characterized by a molecular weight distribution (M_{w}/Mₙ) of from about 2.5 to about 25, in other embodiments from about 3 to about 20, and in other embodiments from about 3.5 to about 10. In these or other embodiments, the linear low density polyethylene may be characterized by a melt flow rate of from about 0.2 to about 10 dg/min, in other embodiments from about 0.4 to about 5 dg/min, and in other embodiments from about 0.6 to about 2 dg/min per ASTM D-1238 at 230° C. and 2.16 kg load.

The linear low density polyethylene of one or more embodiments of this invention may be prepared by using a convention Ziegler Natta coordination catalyst system.

Useful linear low density polyethylene includes those that are commercially available. For example, linear low density polyethylene can be obtained under the tradename Dowlex™ 2267G (Dow); or under the tradename DFDA-1010 NT7 (Dow); or under the tradename GA502023 (Lyondell).

### Functionalized Thermoplastic Polymer

In one or more embodiments, the functionalized thermoplastic polymer includes at least one functional group. The functional group, which may also be referred to as a functional substituent or functional moiety, includes a hetero atom. In one or more embodiments, the functional group includes a polar group. Examples of polar groups include hydroxy, carbonyl, ether, ester halide, amine, imine, nitrile, oxirane (e.g., epoxy ring) or isocyanate groups. Exemplary groups containing a carbonyl moiety include carboxylic acid, anhydride, ketone, acid halide, ester, amide, or imide groups, and derivatives thereof. In one embodiment, the functional group includes a succinic anhydride group, or the corresponding acid, which may derive from a reaction (e.g., polymerization or grafting reaction) with maleic anhydride, or a β-alkyl substituted propanoic acid group or derivative thereof. In one or more embodiments, the functional group is pendant to the backbone of the hydrocarbon polymer. In these or other embodiments, the functional group may include an ester group. In specific embodiments, the ester group is a glycidyl group, which is an ester of glycidol and a carboxylic acid. A specific example is a glycidyl methacrylate group.

In one or more embodiments, the functionalized thermoplastic polymer may be prepared by grafting a graft monomer to a thermoplastic polymer. The process of grafting may include combining, contacting, or reacting a thermoplastic polymer with a graft monomer. These functionalized thermoplastic polymers include those described in U.S. Pat. Nos. 4,957,968, 5624,999, and 6,503,984, which are incorporated herein by reference.

The thermoplastic polymer that can be grafted with the graft monomer may include solid, generally high molecular weight plastic materials. These plastics include crystalline and semi-crystalline polymers. In one or more embodiments, these thermoplastic polymers may be characterized by a crystallinity of at least 20%, in other embodiments at least 25%, and in other embodiments at least 30%. Crystallinity may be determined by dividing the heat of fusion of a sample by the heat of fusion of a 100% crystalline polymer, which is assumed to be 209 joules/gram for polypropylene or 350 joules/gram for polyethylene. Heat of fusion can be determined by differential scanning calorimetry. In these or other embodiments, the thermoplastic polymers to be functionalized may be characterized by having a heat of fusion of at least 40 J/g, in other embodiments in excess of 50 J/g, in other embodiments in excess of 75 J/g, in other embodiments in excess of 95 J/g, and in other embodiments in excess of 100 J/g.

In one or more embodiments, the thermoplastic polymers, prior to grafting, may be characterized by a weight average molecular weight (M_{w}) of from about 100 kg/mole to about 2,000 kg/mole, and in other embodiments from about 300 kg/mole to about 600 kg/mole. They may also characterized by a number-average molecular weight (Mₙ) of about 80 kg/mole to about 800 kg/mole, and in other embodiments about 90 kg/mole to about 200 kg/mole. Molecular weight may be determined by size exclusion chromatography (SEC) by using a Waters 150 gel permeation chromatograph equipped with the differential refractive index detector and calibrated using polystyrene standards.

In one or more embodiments, these thermoplastic polymer, prior to grafting, may be characterized by a melt flow of from about 0.3 to about 2,000 dg/min, in other embodiments from about 0.5 to about 1,000 dg/min, and in other embodiments from about 1 to about 1,000 dg/min, per ASTM D-1238 at 230° C. and 2.16 kg load.

In one or more embodiments, these thermoplastic resins, prior to grafting, may have a melt temperature (Tₘ) that is from about 110° C. to about 250° C., in other embodiments from about 120 to about 170° C., and in other embodiments from about 130° C. to about 165° C. In one or more embodiments, they may have a crystallization temperature (T_{c}) of these optionally at least about 75° C., in other embodiments at least about 95° C., in other embodiments at least about 100° C., and in other embodiments at least 105° C., with one embodiment ranging from 105° to 115° C.

Exemplary thermoplastic polymers that may be grafted include polyolefins, polyolefin copolymers, and non-olefin thermoplastic polymers. Polyolefins may include those thermoplastic polymers that are formed by polymerizing ethylene or α-olefins such as propylene, 1-butene, 1-hexene, 1-octene, 2-methyl-1-propene, 3-methyl-1-pentene, 4-methyl-1-pentene, 5-methyl-1-hexene, and mixtures thereof. Copolymers of ethylene and propylene and ethylene and/or propylene with another α-olefin such as 1-butene, 1-hexene, 1-octene, 2-methyl-1-propene, 3-methyl-1-pentene, 4-methyl-1-pentene, 5-methyl-1-hexene or mixtures thereof is also contemplated. Other polyolefin copolymers may include copolymers of olefins with styrene such as styrene-ethylene copolymer or polymers of olefins with α,β-unsaturated acids, α,β-unsaturated esters such as polyethylene-acrylate copolymers. Non-olefin thermoplastic polymers may include polymers and copolymers of styrene, α,β-unsaturated acids, α,β-unsaturated esters, and mixtures thereof. For example, polystyrene, polyacrylate, and polymethacrylate may be functionalized.

These homopolymers and copolymers may be synthesized by using an appropriate polymerization technique known in the art. These techniques may include conventional Ziegler-Natta, type polymerizations, catalysis employing single-site organometallic catalysts including, but not limited to, metallocene catalysts, and high-pressure free radical polymerizations.

The degree of functionalization of the functionalized thermoplastic polymer may be recited in terms of the weight percent of the pendent functional moiety based on the total weight of the functionalized polymer. In one or more embodiments, the functionalized thermoplastic polymer may include at least 0.2% by weight, in other embodiments at least 0.4% by weight, in other embodiments at least 0.6% by weight, and in other embodiments at least 1.0 weight percent functionalization, in these or other embodiments, the functionalized thermoplastic polymers may include less than 10% by weight, in other embodiments less than 5% by weight, in other embodiments less than 3% by weight, and in other embodiments less than 2% by weight functionalization.

In one or more embodiments, where the functionalized thermoplastic polymer is a functionalized propylene-based polymer, it can be characterized by a melt flow rate of from about 20 to about 2,000 dg/min, in other embodiments from about 100 to about 1,500 dg/min, and in other embodiments from about 150 to about 750 dg/min, per ASTM D-1238 at 230° C. and 2.16 kg load. In one or more embodiments, where the functionalized thermoplastic polymer is a functionalized ethylene-based polymer, it can be characterized by a melt flow index of from about 0.2 to about 2,000 dg/min, in other embodiments from about 1 to about 1,000 dg/min, and in other embodiments from about 5 to about 100 dg/min, per ASTM D-1238 at 190° C. and 2.16 kg load.

Functionalized thermoplastic polymers are commercially available. For example, maleated propylene-based polymers may be obtained under the tradename FUSABOND™ (DuPont), POLYBOND™ (Crompton), and EXXELOR™ (ExxonMobil). Another examples includes polymers or oligomers including one or more glycidyl methacrylate groups such as Lotader™ AX8950 (Arkema).

### Mineral Filler

In one or more embodiments, the fillers, which may also be referred to as mineral fillers, include inorganic materials that may aid in reinforcement, heat aging resistance, green strength performance, and/or flame resistance. In other embodiments, these materials are generally inert with respect to the composition therefore simply act as diluent to the polymeric constituents. In one or more embodiments, mineral fillers include clays, silicates, titanium dioxide, talc (magnesium silicate), mica (mixtures of sodium and potassium aluminum silicate), alumina trihydrate, antimony trioxide, calcium carbonate, titanium dioxide, silica, magnesium hydroxide, calcium borate ore, and mixtures thereof. In one or more embodiments, the fillers are not surface modified or surface functionalized.

Suitable clays may include airfloated clays, water-washed clays, calcined clays, surface-treated clays, chemically-modified clays, and mixtures thereof.

Suitable silicates may include synthetic amorphous calcium silicates, precipitated, amorphous sodium aluminosilicates, and mixtures thereof.

Suitable silica (silicon dioxide) may include wet-processed, hydrated silicas, crystalline silicas, and amorphous silicas (noncrystalline).

In one or more embodiments, the mineral fillers are characterized by an average particle size of at least 1 μm, in other embodiments at least 2 μm, in other embodiments at least 3 μm, in other embodiments at least 4 μm, and in other embodiments at least 5 μm. In these or other embodiments, the mineral fillers are characterized by an average particle size of less than 15 μm, in other embodiments less than 12 μm, in other embodiments less than 10 μm, and in other embodiments less than 8 μm. In these or other embodiments, the mineral filler has an average particle size of between 1 and 15 μm, in other embodiments between 3 and 12 μm, and in other embodiments between 6 and 10 μm.

### Other Ingredients

The thermoplastic membranes of the present invention may also include other ingredients such as those that are convention in thermoplastic membranes. For example, other useful additives or constituents may include flame retardants, stabilizers, pigments, and fillers.

In one or more embodiments, useful flame retardants include and compound that will increase the burn resistivity, particularly flame spread such as tested by UL 94 and/or UL 790, of the laminates of the present invention. Useful flame retardants include those that operate by forming a char-layer across the surface of a specimen when exposed to a flame. Other flame retardants include those that operate by releasing water upon thermal decomposition of the flame retardant compound. Useful flame retardants may also be categorized as halogenated flame retardants or non-halogenated flame retardants.

Exemplary non-halogenated flame retardants include magnesium hydroxide, aluminum trihydrate, zinc borate, ammonium polyphosphate, melamine polyphosphate, and antimony oxide (Sb₂O₃). Magnesium hydroxide (Mg(OH)₂) is commercially available under the tradename Vertex™ 60, ammonium polyphosphate is commercially available under the tradename Exolite™ AP 760 (Clarian), which is sold together as a polyol masterbatch, melamine polyphosphate is available under the tradename Budit™ 3141 (Budenheim), and antimony oxide (Sb₂O₃) is commercially available under the tradename Fireshield™. Those flame retardants from the foregoing list that are believed to operate by forming a char layer include ammonium polyphosphate and melamine polyphosphate.

In one or more embodiments, treated or functionalized magnesium hydroxide may be employed. For example, magnesium oxide treated with or reacted with a carboxylic acid or anhydride may be employed. In one embodiment, the magnesium hydroxide may be treated or reacted with stearic acid. In other embodiments, the magnesium hydroxide may be treated with or reacted with certain silicon-containing compounds. The silicon-containing compounds may include silanes, polysiloxanes including silane reactive groups. In other embodiments, the magnesium hydroxide may be treated with maleic anhydride. Treated magnesium hydroxide is commercially available. For example, Zerogen™ 50.

Examples of halogenated flame retardants may include halogenated organic species or hydrocarbons such as hexabromocyclododecane or N,N′-ethylene-bis-(tetrabromophthalimide). Hexabromocyclododecane is commercially available under the tradename CD-75P™ (ChemTura). N,N′-ethylene-bis-(tetrabromophthalimide) is commercially available under the tradename Saytex™ BT-93 (Albemarle).

In one or more embodiments, the use of char-forming flame retardants (e.g. ammonium polyphosphate and melamine polyphosphate) has unexpectedly shown advantageous results when used in conjunction with nanoclay within the cap layer of the laminates of the present invention. It is believed that there may be a synergistic effect when these compounds are present in the cap layer. As a result, the cap layer of the laminates of the certain embodiments of the present invention are devoid of or substantially devoid of halogenated flame retardants and/or flame retardants that release water upon thermal decomposition. Substantially devoid referring to that amount or less that does not have an appreciable impact on the laminates, the cap layer, and/or the burn resistivity of the laminates.

In one or more embodiments, the membranes of the invention may include a stabilizers. Stabilizers may include one or more of a UV stabilizer, an antioxidant, and an antiozonant. UV stabilizers include Tinuvin™ 622. Antioxidants include Irganox™ 1010.

### Amounts Functionalized Polymer

In one or more embodiments, the one or more layers of the membranes of the present invention that include the functionalized polymer include at least 1 weight percent, in other embodiments at least 2 weight percent, in other embodiments at least 3 weight percent, in other embodiments at least 5 weight percent, and in other embodiments at least 7 weight percent of the functionalized polymer (e.g. hydroxyl-bearing polymer) based on the entire weight of the given layer of the membrane that includes the functionalized polymer. In one or more embodiments, the one or more layers of the membranes of the present invention that include the functionalized polymer include at most 50 weight percent, in other embodiments at most 25 weight percent, and in other embodiments at most 15 weight percent of the functionalized polymer based on the entire weight of the given layer of the membrane that includes the functionalized polymer. In one or more embodiments, the one or more layers of the membranes of the present invention that include the functionalized polymer include from about 3 to about 50, in other embodiments from about 5 to about 25, and in other embodiments from about 7 to about 15 weight percent of the functionalized polymer based upon the entire weight of the given layer of the membrane that includes the functionalized polymer.

### Filler

As discussed above, one or more layers of the membranes of the present invention include, along with functionalized polymer, a relatively high loading of filler. As used herein, relatively high loading of filler refers to that amount or more of filler that would have an appreciable and deleterious impact on the membrane in the absence of the functionalized polymer including, but not limited to, precluding the membrane from use in a mechanically-attached roofing system while meeting applicable industry standards. In one or more embodiments, the one or more layers of the membranes of the present invention that include the high loading of filler include at least 10, in other embodiments at least 15 weight percent, in other embodiments at least 20 weight percent, in other embodiments at least 25 weight percent, in other embodiments at least 30 weight percent, 33 weight percent, in other embodiments at least 40 weight percent, and in other embodiments at least 45 weight percent of the filler (e.g. mineral filler) based on the entire weight of the given layer of the membrane that includes the filler. In one or more embodiments, the one or more layers of the membranes of the present invention that include the high loading of filler include at most 80 weight percent, in other embodiments at most 70 weight percent, and in other embodiments at most 60 weight percent of the filler based on the entire weight of the given layer of the membrane that includes the filler. In one or more embodiments, the one or more layers of the membranes of the present invention that include the high loading of filler include from about 33 to about 80, in other embodiments from about 40 to about 70, and in other embodiments from about 45 to about 60 weight percent of the filler based upon the entire weight of the given layer of the membrane that includes the filler.

In one or more specific embodiments, the membranes of the present invention are bilaminate membranes (optionally scrim-reinforced) that satisfy the requirements of ASTM 6878-03. The membranes of these embodiments include an upper layer (e.g., upper layer 14 in FIG. 1) that includes at least 15 weight %, in other embodiments at least 25 weight %, in other embodiments at least 30 weight %, and in other embodiments at least 35 weight % magnesium hydroxide. Additionally, the membranes of these embodiments include a lower layer (e.g., lower layer 12 of FIG. 1 opposite the scrim from layer 12) that includes at least 5 weight %, in other embodiments at least 10 weight %, in other embodiments at least 15 weight %, in other embodiments at least 20 weight %, in other embodiments at least 25 weight %, and in other embodiments at least 30 weight % mineral filler, and also includes the functionalized polymer according to embodiments of the invention. In particular embodiments, the lower layer (e.g., layer 12) includes mineral filler other than magnesium hydroxide (e.g., calcium carbonate). In particular embodiments, the lower layer (e.g., layer 12) includes magnesium hydroxide in combination with another mineral filler such as calcium carbonate.

In yet other embodiments, bilaminate membranes (optionally scrim-reinforced) satisfying the requirements of ASTM 6878-03 are prepared and include a coextruded upper layer that includes at least two coextruded layers as shown in FIGS. 1 and 2 (e.g., coextruded layers 28 and 38). In these embodiments, upper most coextruded layer 30 includes at least 15 weight %, in other embodiments at least 25 weight %, in other embodiments at least 30 weight %, and in other embodiments at least 35 weight % magnesium hydroxide. Additionally, upper middle layer 28, as well as lower layer 12 (which may include coextruded layers 24 and 26), includes at least 5 weight %, in other embodiments at least 10 weight %, in other embodiments at least 15 weight %, in other embodiments at least 20 weight %, in other embodiments at least 25 weight %, and in other embodiments at least 30 weight % mineral filler, and also includes the functionalized polymer according to embodiments of the invention. In one or more embodiments, the mineral filler in lower layer 12 and upper middle layer 28 is a mineral filler other than calcium carbonate. In other embodiments, lower layer 12 and upper middle layer 28 include magnesium hydroxide in combination with another mineral filler such as calcium carbonate.

### Method of Making

In one or more embodiments, the compositions and membranes of the present invention may be prepared by employing conventional techniques. For example, the various ingredients can be separately fed into a reaction extruder and pelletized or directly extruded into membrane or laminate sheet. In other embodiments, the various ingredients can be combined and mixed within a mixing apparatus such as an internal mixer and then subsequently fabricated into membrane sheets or laminates.

In one or more embodiments, the membranes of the present invention may be prepared by extruding a polymeric composition into a sheet. Multiple sheets may be extruded and joined to form a laminate. A membrane including a reinforcing layer may be prepared by extruding at least one sheet on and/or below a reinforcement (e.g., a scrim). In other embodiments, the polymeric layer may be prepared as separate sheets, and the sheets may then be calandered with the scrim sandwiched there between to form a laminate. In one or more embodiments, the membranes of the present invention are prepared by employing coextrusion technology. Useful techniques include those described in co-pending U.S. Ser. Nos. 11/708,898 and 11/708,903, which are incorporated herein by reference.

Following extrusion, and after optionally joining one or more polymeric layers, or optionally joining one or more polymeric layer together with a reinforcement, the membrane may be fabricated to a desired thickness. This may be accomplished by passing the membrane through a set of squeeze rolls positioned at a desired thickness. The membrane may then be allowed to cool and/or rolled for shipment and/or storage.

The polymeric composition that may be extruded to form the polymeric sheet may include the ingredients or constituents described herein. For example, the polymeric composition may include thermoplastic polyolefin, filler, and functionalized polymers defined herein. The ingredients may be mixed together by employing conventional polymer mixing equipment and techniques. In one or more embodiments, an extruder may be employed to mix the ingredients. For example, single-screw or twin-screw extruders may be employed.

### INDUSTRIAL APPLICABILITY

The membranes of one or more embodiments of the present invention are useful in a number of applications. In one embodiment, the membranes may be useful for roofing membranes that are useful for covering flat or low-sloped roofs. In other embodiments, the membranes may be useful as geomembranes. Geomembranes include those membranes employed as pond liners, water dams, animal waste treatment liners, and pond covers.

As described above, the membranes of one or more embodiments of the present invention may be employed as roofing membranes. These membranes include thermoplastic roofing membranes including those that meet the specifications of ASTM D-6878-03. These membranes maybe employed to cover flat or low/sloped roofs. These roofs are generally known in the art as disclosed in U.S. Ser. Nos. 60/586,424 and 11/343,466, and International Application No. PCT/US2005/024232, which are incorporated herein by reference.

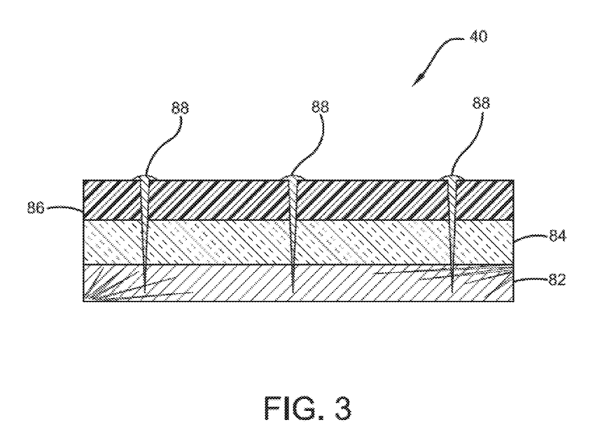

In one or more embodiments, the membranes of the present invention can advantageously be used to prepare mechanically-attached roofing systems. For example, as shown in FIG. 3, a mechanically-attached roofing system 40 include roof deck 82, optional insulation layer 84, thermoplastic membrane 86, which is in accordance with the present invention, and a plurality of fasteners 88.

Advantageously, the process can be used to construct a mechanically-attached roofing system meeting the standards of UL and Factory Mutual for wind uplift (e.g., FM 4470).

The substrate to which the membrane may be mechanically attached may include a roof deck, which may include steel, concrete, and/or wood. In these or other embodiments, the membranes may be applied over additional materials, such as insulation boards and cover boards. As those skilled in the art appreciate, insulation boards and cover boards may carry a variety of facer materials including, but not limited to, paper facers, fiberglass-reinforced paper facers, fiberglass facers, coated fiberglass facers, metal facers such as aluminum facers, and solid facers such as wood. In yet other embodiments, the membranes may be applied over existing membranes. These existing membranes may include cured rubber systems such as EPDM membranes, thermoplastic polymers systems such as TPO membranes, or asphalt-based systems such as modified asphalt membranes and/or built roof systems. Regardless of any intervening materials, the membrane may ultimately be mechanically attached to the roof deck using known techniques.

Practice of this invention is not limited by the selection of any particular roof deck. Accordingly, the roofing systems herein can include a variety of roof decks. Exemplary roof decks include concrete pads, steel decks, wood beams, and foamed concrete decks.

Practice of this invention is likewise not limited by the selection of any particular insulation board. Moreover, the insulation boards are optional. Several insulation materials can be employed including polyurethane or polyisocyanurate cellular materials. These boards are known as described in U.S. Pat. Nos. 6,117,375, 6,044,604, 5,891,563, 5,573,092, U.S. Publication Nos. 2004/01099832003/0082365, 2003/0153656, 2003/0032351, and 2002/0013379, as well as U.S. Ser. Nos. 10/640,895, 10/925,654, and 10/632,343, which is incorporated herein by reference.

In other embodiments, these membranes may be employed to cover flat or low-slope roofs following a re-roofing event. In one or more embodiments, the membranes may be employed for re-roofing as described in U.S. Publication No. 2006/0179749, which are incorporated herein by reference.

In order to demonstrate the practice of the present invention, the following examples have been prepared and tested. The examples should not, however, be viewed as limiting the scope of the invention. The claims will serve to define the invention.

### EXAMPLES

Three thermoplastic compositions were prepared and tested for tear strength. The ingredients employed and the results of testing are provided in the table.

| TABLE | | |
|---|---|---|
| Sample | | |
| 1 | 2 | 3 |

Ingredients

| | | | |
|---|---|---|---|
| Thermoplastic Polymer | 94 | 79 | 71.35 |
| Functionalized Thermoplastic | — | — | 7.65 |
| Stabilizer Package | 1 | 1 | 1 |
| Magnesium Hydroxide | 5 | 5 | 5 |
| Ground Filler | — | 15 | 15 |
| Total | 100 | 100 | 100 |

Die C. Tear MD (Unaged)

| | | | |
|---|---|---|---|
| Thickness | 0.036 | 0.035 | 0.043 |
| Maximum Load (lbf) | 17 | 14 | 21 |
| Tear Strenth (lbf/in) | 459 | 413 | 500 |

The thermoplastic polymer included in-reactor polyolefins obtained under the trademane HIFAX (Lyondellbassel). The functionalized thermoplastic was a maleic anhydride modified polypropylene obtained under the tradename EXXELOR PO 1020 (ExxonMobil). The ground filler was an untreated calcium carbonate having an average particle size of 5.5 micron. Die C Tear was conducted according to ASTM 6878-03.

Various modifications and alterations that do not depart from the scope and spirit of this invention will become apparent to those skilled in the art. This invention is not to be duly limited to the illustrative embodiments set forth herein.

1. A thermoplastic roofing membrane comprising:
a planar sheet of thermoplastic polymer, optionally having more than one layer, where at least one layer of the membrane includes a functionalized thermoplastic polymer and at least 10 percent by weight filler, based on the total weight of the at least one layer.

2. The roofing membrane of claim 1, where the membrane is a bilaminate membrane including upper and lower layers.

3. The roofing membrane of claim 3, where the lower layer includes the functionalized thermoplastic polymer and the filler.

4. The roofing membrane of claim 1, where the membrane is a multi-layered membrane including at least one pair of coextruded layers, where at least one of said pair of coextruded layers includes the functionalized thermoplastic polymer and the filler.

5. The roofing membrane of claim 1, where the functionalized thermoplastic polymer and the filler are dispersed within the thermoplastic polymer.

6. The roofing membrane of claim 5, where the thermoplastic polymer is a propylene-based polymer.

7. The roofing membrane of claim 6, where the propylene-based polymer is non-functionalized.

8. The roofing membrane of claim 1, where the filler is selected from the group consisting of clays, silicates, titanium dioxide, talc (magnesium silicate), mica (mixtures of sodium and potassium aluminum silicate), alumina trihydrate, antimony trioxide, calcium carbonate, titanium dioxide, silica, magnesium hydroxide, calcium borate ore, and mixtures thereof.

9. The roofing membrane of claim 8, where the filler is calcium carbonate or magnesium hydroxide.

10. (canceled)

11. A mechanically-attached roofing system comprising:
i. a roof substrate;
ii. a thermoplastic membrane including at least one layer that includes a functionalized thermoplastic polymer and at least 10 percent by weight filler, based on the total weight of the at least one layer; and
iii. fasteners that fasten the thermoplastic membrane to the roof substrate.

12. The roofing system of claim 11, where the roofing system includes a layer of insulation disposed between said roof substrate and said thermoplastic membrane.

13. The roofing system of claim 11, where the membrane is a bilaminate membrane including upper and lower layers.

14. The roofing system of claim 13, where the lower layer includes the functionalized thermoplastic polymer and the filler.

15. The roofing system of claim 11, where the membrane is a multi-layered membrane including at least one pair of coextruded layers, where at least one of said pair of coextruded layers includes the functionalized thermoplastic polymer and the filler.

16. The roofing system of claim 11, where the functionalized thermoplastic polymer and the filler are dispersed within the thermoplastic polymer.

17. The roofing system of claim 16, where the thermoplastic polymer is a propylene-based polymer.

18. The roofing system of claim 17, where the propylene-based polymer is non-functionalized.

19. The roofing system of claim 11, where the filler is selected from the group consisting of clays, silicates, titanium dioxide, talc (magnesium silicate), mica (mixtures of sodium and potassium aluminum silicate), alumina trihydrate, antimony trioxide, calcium carbonate, titanium dioxide, silica, magnesium hydroxide, calcium borate ore, and mixtures thereof.

20. The roofing system of claim 19, where the filler is calcium carbonate or magnesium hydroxide.

21. (canceled)

22. A method for forming a mechanically-attached roof system, the method comprising:
i. applying a membrane to a roof substrate, wherein the membrane includes a planar sheet of thermoplastic polymer, optionally having more than one layer, where at least one layer of the membrane includes a functionalized thermoplastic polymer and at least 10 percent by weight filler, based on the total weight of the at least one layer; and
ii. mechanically fastening the membrane to the substrate.
